(19) United States
(12) Patent Application Publication
(10) Pub. No.: US 2011/0280016 A1
(43) Pub. Date: Nov. 17, 2011

(54) Heat sink and cooling method for LED lighting and other applications

(76) Inventors: Ronald A. Content, Oakville (CA); Jagath A. Swaris, Burlington (CA)

(21) Appl. No.: 13/068,453

(22) Filed: May 11, 2011

Related U.S. Application Data
(60) Provisional application No. 61/334,173, filed on May 12, 2010.

(51) Int. Cl. F21S 4/00; F28F 7/00; B21D 53/02; F21S 8/06

(52) U.S. Cl. 362/249.02; 362/404; 165/185; 29/890.03

(57) ABSTRACT

An inventive heat sink adapted for use with light emitting diode luminaires and other applications comprising: a first layer of carbon graphite in thermal communication with a source of heat and a second layer of aluminum in thermal communication with said first layer. Also disclosed is an inventive troffer including a frame; a printed circuit board mounted within the frame; an array of light emitting diodes mounted on the printed circuit board; a heat sink mounted in parallel with the printed circuit board; and a thermal interface layer disposed between the heat sink and the printed circuit board. In yet another embodiment, the inventive troffer assembly includes plural modules mounted within the frame, each module including: a printed circuit board mounted within the frame; an array of light emitting diodes mounted on the printed circuit board; a heat sink mounted in parallel with the printed circuit board; and a thermal interface layer disposed between the heat sink and the printed circuit board.

### REFERENCE TO RELATED APPLICATION

This is a nonprovisional application claiming priority from a provisional application entitled Lighting Apparatus, Heat Sinks and Methods of Manufacturing filed May 12, 2010, Ser. No. 61/334,173, (Attorney Docket No. 1011-003).

### BACKGROUND OF THE INVENTION

1. Field of the Invention

The present invention relates to lighting systems. More specifically, the present invention relates to heat sinks for light emitting diode based lighting systems.

2. Description of the Related Art

As noted in Wikipedia at http://en.wikipedia.org/wiki/Light-emitting diode a light-emitting diode (LED) is a semiconductor light source. LEDs are used as indicator lamps in many devices and are increasingly used for general lighting applications. Introduced as a practical electronic component in 1962, early LEDs emitted low-intensity red light, but modern versions are available across the visible, ultraviolet and infrared wavelengths, with very high brightness.

When a light-emitting diode is forward biased (switched on), electrons are able to recombine with electron holes within the device and release energy in the form of photons. This effect is called electroluminescence. The color of the light (corresponding to the energy of the photon) is determined by the energy gap of the semiconductor.

With the development of high efficiency and high power LEDs it has become possible to use LEDs in general (i.e., commercial, industrial and other) lighting and illumination applications. LEDs present many advantages over fluorescent and incandescent light sources including lower energy consumption, longer lifetime, improved robustness, smaller size, faster switching, and greater durability and reliability. For example, while incandescent lights may be expected to last for 2-3,000 hours and fluorescent lights may be expected to last for 15-20,000 hours, LEDs may be expected to last for 70,000-100,000 hours, however heat and current settings can extend or shorten this time significantly.

For certain applications, such clean rooms in the semiconductor industry, re- lamping may be quite expensive costing millions, especially in view of the fact that production must typically be stopped throughout the process. For such applications, long life and reliability are critical. However, LEDs powerful enough for room lighting are relatively expensive and require more precise current and heat management than compact fluorescent lamp sources of comparable output. Hence, cooling of LEDs may be critically important for some applications.

Prior attempts to cool LED based lighting systems include various heat extraction designs and pulsing the LEDs. However, these approaches have been costly in the use of aluminum or metal core circuit boards and have been only minimally effective. Hence, a need remains in the art for a less expensive and more effective system or method for extracting heat from large LED arrays used in lighting applications.

### SUMMARY OF THE INVENTION

The need in the art is addressed by the system and method of the present teachings. The invention includes an inventive heat sink adapted for use with light emitting diode luminaires and other applications comprising: a first layer of carbon graphite in thermal communication with a source of heat and a second layer of aluminum in thermal communication with said first layer.

The present teachings provide an inventive troffer including a frame; a printed circuit board mounted within the frame; an array of light emitting diodes mounted on the printed circuit board; a heat sink mounted in parallel with the printed circuit board; and a thermal interface layer disposed between the heat sink and the printed circuit board.

In yet another embodiment, the inventive troffer assembly includes plural modules mounted within the frame, each module including: a printed circuit board mounted within the frame; an array of light emitting diodes mounted on the printed circuit board; a heat sink mounted in parallel with the printed circuit board; and a thermal interface layer disposed between the heat sink and the printed circuit board.

### BRIEF DESCRIPTION OF THE DRAWINGS

FIGS. 1 and 2 are top and bottom views respectively of a troffer assembly according to a first illustrative embodiment of the present invention.

FIG. 2a is an alternative embodiment of the troffer assembly of FIG. 2 wherein the extruded fins are omitted from the heat sink.

FIGS. 3 and 4 are top and bottom views respectively of a lighting apparatus comprising the troffer assembly of FIGS. 1 and 2.

FIG. 3a is an exploded view of the heat sink assembly of FIGS. 1-3.

FIG. 5 is a perspective view of a first segment of a heat sink that could be incorporated into the troffer assembly of FIGS. 1 and 2.

FIG. 5a is a magnified view of a portion of the heat sink segment depicted in FIG. 5.

FIG. 6 is a perspective view of a second segment of a heat sink that could be incorporated into the troffer assembly of FIGS. 1 and 2.

FIG. 6a is a magnified view of a portion of the second segment depicted in FIG. 6.

FIG. 7 is a perspective view of an assembled heat sink comprising the first and second segments of FIGS. 5 and 6.

FIG. 7a is a magnified view of a portion of the heat sink depicted in FIG. 7.

FIG. 8 is a detailed schematic of the heat sink of FIG. 7.

FIGS. 9 and 10 are top and bottom views respectively of a troffer assembly according to a second embodiment of the present invention.

FIG. 11 is a side view of a lighting apparatus comprising the troffer assembly of FIGS. 9 and 10.

FIGS. 12 and 13 are perspective views of first and second segments respectively of a heat sink that could be incorporated into the troffer assembly of FIGS. 9 and 10.

FIGS. 12a and 13a are magnified views of portions of the segments depicted in FIGS. 12 and 13 respectively.

FIG. 14 is a perspective view of an assembled heat sink comprising the first and second segments of FIGS. 12 and 13.

FIG. 14a is a magnified view of a portion of the assembled heat depicted in FIG. 14.

FIG. 15 is a detailed schematic of the heat sink of FIG. 14.

FIG. 16 shows an alternative embodiment in which the troffer assembly includes four modules instead of one.

FIG. 17 is a perspective view showing the completed lighting assembly.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention is directed to lighting apparatus using a troffer assembly, heat sinks and methods of manufacturing lighting apparatus and heat sinks. In embodiments of the present invention, the lighting apparatus is designed as a light emitting diode (LED) luminaire that can replace traditional fluorescent-based troffers that are often implemented as recessed down lights in offices and schools. In particular designs, the troffer assembly has dimensions that can allow for direct replacement of troffers that are implemented with sockets for fluorescent light bulbs.

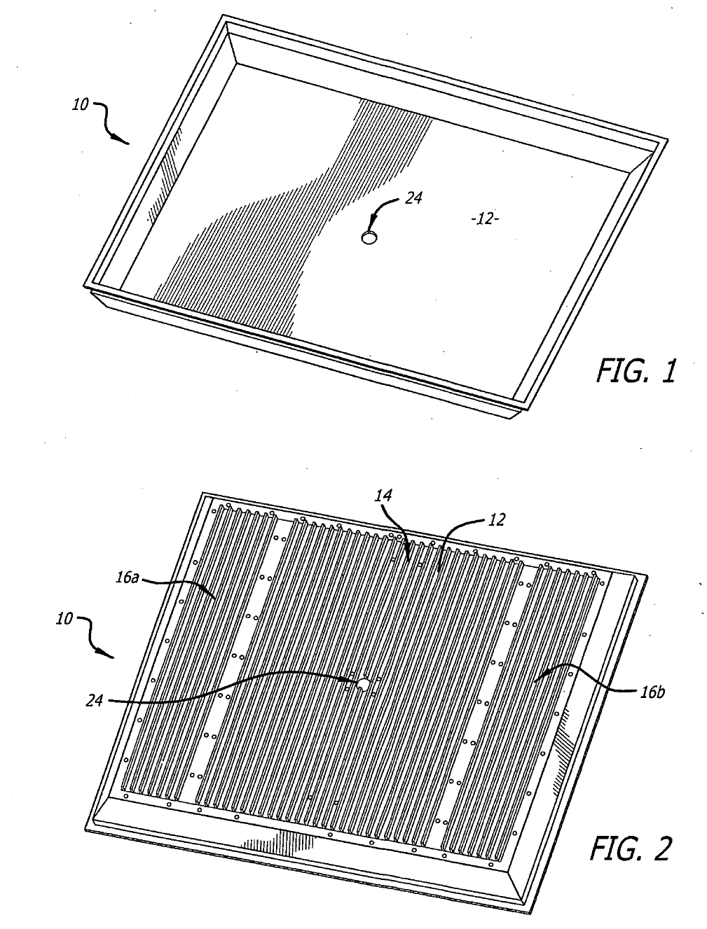

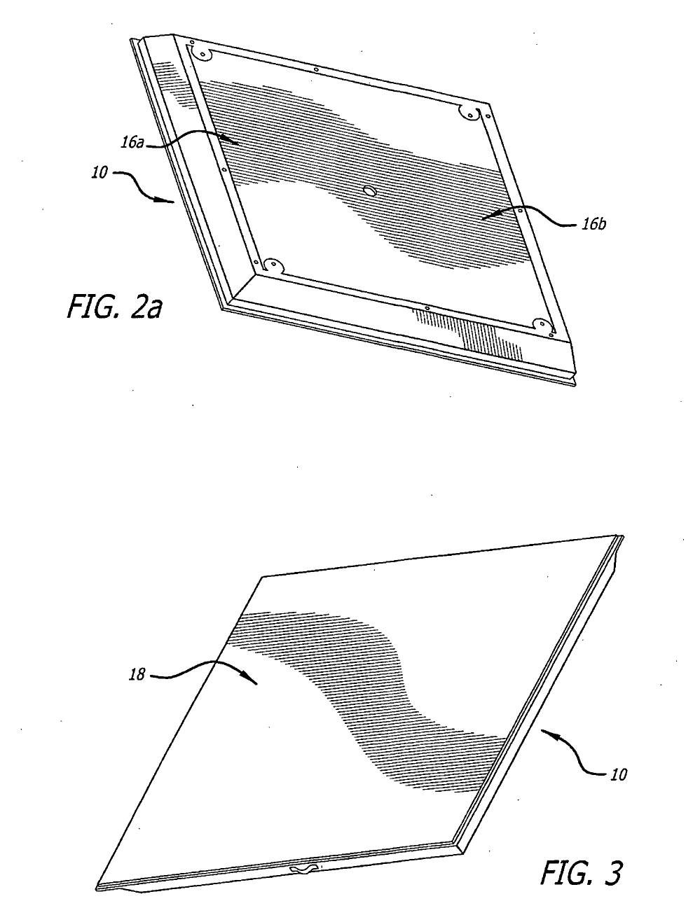

FIGS. 1 and 2 are top and bottom views respectively of a troffer assembly according to a first embodiment of the present invention. As shown, the troffer assembly comprises a frame 10 having four sides that form an edge of a container with front and back square planar sides. The front and back planar sides of the container each have a hole that is substantially the size of the respective planar sides, hence leaving both planar sides open with the frame 10 only forming the outside edge of the container.

The troffer assembly, as shown in FIGS. 1 and 2, further comprises a heat sink 12 connected to the frame 10 at the back planar side of the container. In this embodiment, the heat sink 12 has a planar dimension substantially similar to the dimension of the hole in the back planar side of the container. The heat sink is connected to the frame 10 along the edge of the hole in the back planar side of the container such that the hole is fully covered. The heat sink 12 may be connected to the frame 10 with a series of screws or alternatively another fastening mechanism (ex. interlocking connection, clips, snap connection, affixing agent etc.).

As shown in FIGS. 1 and 2, the heat sink 12 comprises first and second planar sides. The first planar side of the heat sink 12 is a flat surface and forms an interior side of the container. When the lighting apparatus according to embodiments of the present invention is assembled, one or more light engine modules (not shown) comprising LEDs are both physically and thermally coupled to the first planar side of the heat sink 12.

In the illustrative embodiment of FIGS. 1 and 2, the second planar side of the heat sink 12 comprises a plurality of fins 13 and forms an exterior side of the container. The fins on the second planar side of the heat sink 12 provide additional surface area for heat within the heat sink to be dispersed through passive air-cooling. In the case shown in FIG. 2, there are numerous narrow longitudinal fins that are substantially perpendicular with the second planar side of the heat sink 12. It should be understood that in other embodiments other implementations for increasing the surface area of the heat sink 12 and/or other cooling techniques may be used within the heat sink 12.

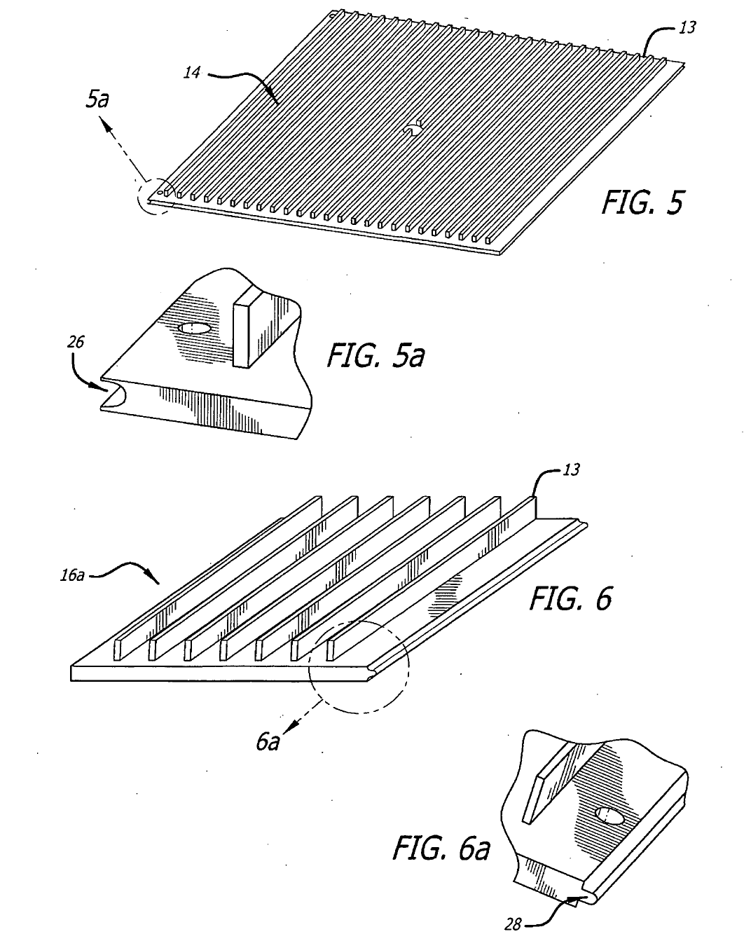

As shown in FIG. 2, the heat sink 12 comprises a central heat sink segment 14 and two edge heat sink segments 16a, 16b connected to the central heat sink segment 14. These three segments are assembled together as will be described in detail with reference to FIGS. 5 to 8. This method is employed to changed the size of the heat sink by simply altering the middle section.

The lighting apparatus incorporating the troffer assembly of embodiments of the present invention will likely be installed within a ceiling as a recessed down light. In this configuration, there may be requirements to insulate electrical circuitry of the LEDs from the interior of the ceiling. This requirement is met in the embodiment of FIGS. 1 and 2 since the heat sink 12 substantially covers the hole within the back planar side of the container, thus separating any electrical circuitry within the troffer assembly from the interior of the ceiling. This requirement is met without needing to extend the frame 10 over the back planar side of the container, which may have limited the effectiveness of the heat sink 12. In particular, the fins within the heat sink 12 would lose effectiveness if implemented within the interior of the container, due to limited airflow to perform passive cooling within the container.

Although the troffer assembly of FIGS. 1 and 2 has a single hole in the back planar side of the container, in other embodiments, the frame 10 may form the back planar side of the container and there may be a plurality of holes within the frame 10. In this case, there may be a plurality of heat sinks, each heat sink having a planar dimension substantially similar to the dimension of a corresponding hole in the frame 10 within the back planar side of the container.

In these embodiments, there remains physical separation between the electrical circuitry within the troffer assembly and the interior of the ceiling while still allowing the heat sinks have a planar side exterior to the container.

In one specific implementation, for each light engine module implemented within the lighting apparatus of the present invention, there may be a corresponding hole in the back planar side of the frame 10 and a corresponding heat sink that covers the hole. In this implementation, each light engine module could be physically and thermally coupled to a separate heat sink.

For example, in the case that there are four light engine modules implemented within a lighting apparatus according to an embodiment of the present invention, each light engine module being approximately the size of one quarter of the heat sink 12 in FIG. 1, the frame 10 may include two perpendicular elements that cross the back planar side of the container in order to divide the back planar side of the container into four equal squares. In this case, four heat sinks could be integrated within the back planar side of the container, each one being physically and thermally coupled to a separate light engine module.

Although the planar sides of the troffer assembly of FIGS. 1 and 2 are in the shape of a square, this should not limit the scope of the present invention. In particular, there are numerous planar shapes possible for a troffer assembly of the present invention. Specifically, the planar sides of the container formed with the frame 10 could be any two- dimensional shape including a rectangle, a triangle, another polygon or even a circle or oval.

FIG. 2a is an alternative embodiment of the heat sink of FIG. 2 wherein the extruded fins 13 are omitted.

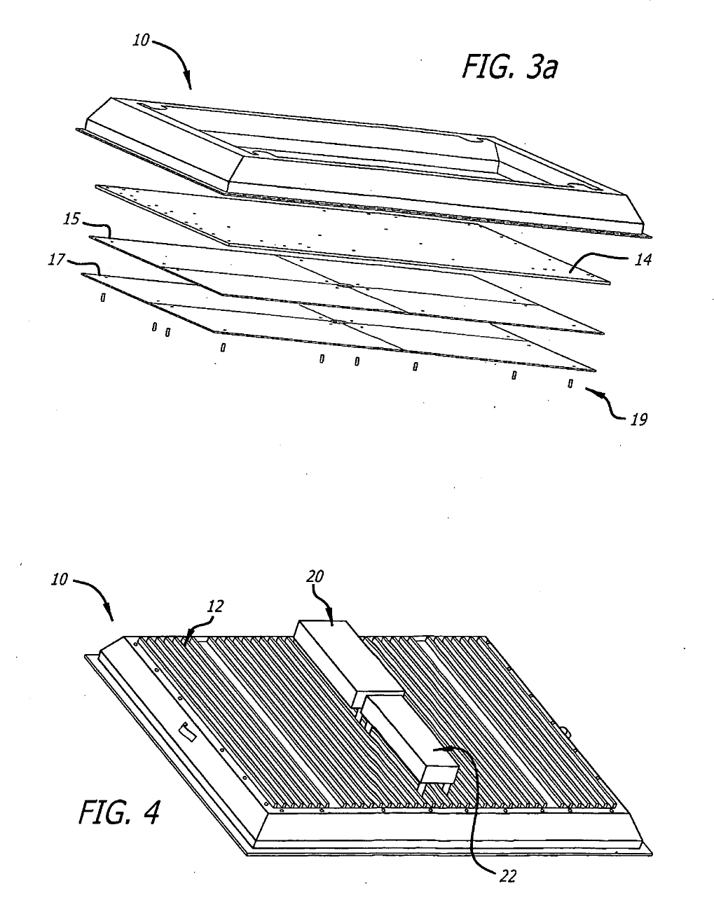

FIGS. 3 and 4 are top and bottom views respectively of a lighting apparatus comprising the troffer assembly of FIGS. 1 and 2. As shown, the lighting apparatus comprises the frame 10 and heat sink 12 of FIGS. 1 and 2 and further comprise a planar optical element 18 connected to the frame 10 along the edge of the hole in the front planar side of the container. The optical element 18 may be connected to the frame 10 with an interlocking connection or alternatively another fastening mechanism (ex. screws, clips, snap connection, affixing agent etc.). The planar optical element 18 is used to diffuse light generated from light engine modules (not shown) within the troffer assembly. As shown in FIG. 3, the planar optical element 18 has planar dimensions substantially similar to dimensions of the hole in the front planar side of the frame 10 such that it covers the hole when installed.

FIG. 3a is an exploded view of the heat sink assembly of FIGS. 1-3. As shown in FIG. 3a, a particularly novel and advantageous feature of the present invention is the provision of a thermal interface layer 15 between the heat sink 14 and a printed circuit board 17 of the assembly 10 onto which the LEDs (not shown) are mounted. In the illustrative embodiment, the thermal interface layer 17 includes a thin layer of carbon graphite to maximize thermal extraction. The thermal interface layer 17 provides heat extraction in excess of 600 W/m-K in the x-y plane (along the surface of the material) and good extraction through the material (in the z plane) as well. This offers a significant improvement over convention heat sinks that perform well in the extraction of heat in the z-direction and poor heat extraction along the x-y plane thereof.

The lighting apparatus, as shown in FIG. 4, further comprises an AC/DC power supply module 20 and a lighting control module 22 connected to the second planar side of the heat sink 12. In this case, the AC/DC power supply module 20 and the lighting control module comprise an AC/DC power supply and a lighting controller respectively encapsulated within respective rectangular encasements. The AC/DC power supply and the lighting controller are electrically coupled to each other and manage the DC power to the light engine modules within the lighting apparatus. Cables (not shown) connecting the lighting controller to the light engine modules can be wired through a hole 24 within the center of the heat sink 12 that is shown in FIGS. 1 and 2. As shown in FIG. 4, the hole 24 is covered by one of the power supply module 20 and/or the light control module 22.

FIGS. 5 through 8 are directed to components of the heat sink 12 and assembly of those components to manufacture the heat sink 12. FIG. 5 is a perspective view of the central heat sink segment 14 of the heat sink 12 illustrated within FIG. 2. FIG. 5a is a magnified view of a portion of the heat sink segment depicted in FIG. 5. As shown, the central heat sink segment 14 comprises a plurality of fins 13 coupled to and substantially perpendicular to the second planar surface of the central heat sink segment 14. On either edge perpendicular to the fins, the central heat sink segment 14 comprises a coupling mechanism 26. (See FIG. 5a.) As shown, the coupling mechanism 26 comprises a female portion of an interlocking connection, though other mechanisms for coupling to other heat sink segments could be used.

FIG. 6 is a perspective view of one of the edge heat sink segments 16a of the heat sink 12 illustrated within FIG. 2. FIG. 6a is a magnified view of a portion of the second segment depicted in FIG. 6. As shown, similar to the central heat sink segment 14 of FIG. 5, the edge heat sink segment 16a comprises a plurality of fins 13 coupled to and substantially perpendicular to the second planar surface of the edge heat sink segment 16a. On one edge perpendicular to the fins, the edge heat sink segment 16a comprises a coupling mechanism 28. As shown, the coupling mechanism 28 comprises a male portion of an interlocking connection that could interlock with the female portion of the central heat sink portion of FIG. 5, though other mechanisms for coupling to other heat sink segments could be used.

FIG. 7 is a perspective view of the heat sink 12 after the central heat sink segment 14 has been assembled with the two edge heat sink segments 16a, 16b. FIG. 7a is a magnified view of a portion of the heat sink depicted in FIG. 7. As shown, the coupling mechanism 26 of the central heat sink segment 14 and the coupling mechanism 28 of the edge heat sink segment 16a interlock together to form a connection 30. A similar connection can be made between the central heat sink segment 14 and the edge heat sink segment 16b. Further, in some embodiments, other coupling mechanisms may be used as well or in place of the coupling mechanism shown in FIG. 7. For example, to assemble the heat sink segments 14, 16a, 16b screws, clips, snap connection, affixing agent etc. may be used.

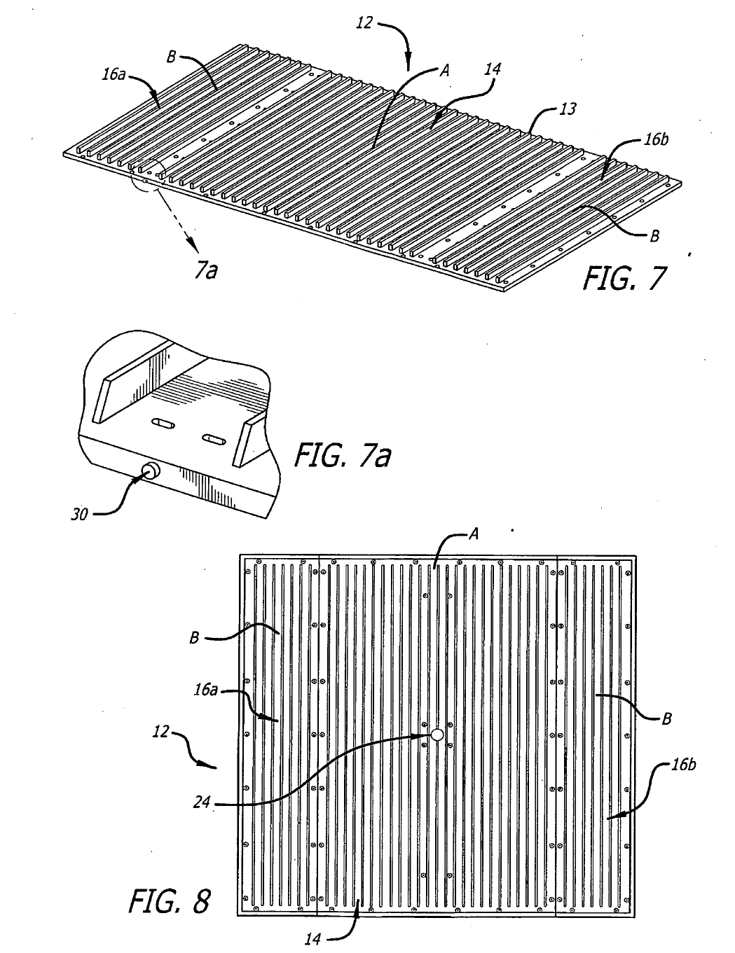

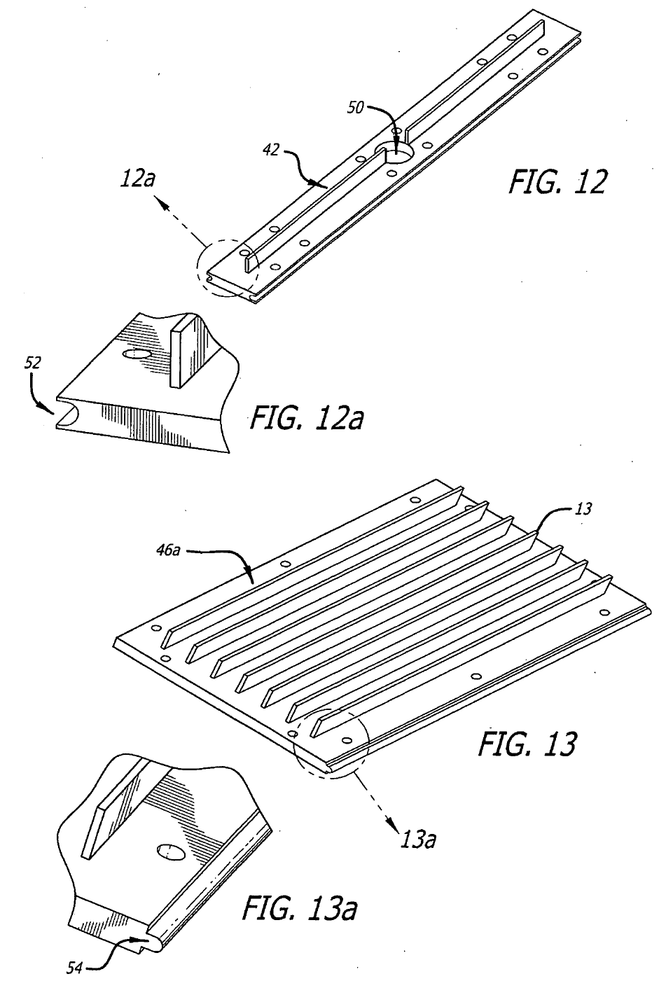

FIG. 8 is a detailed schematic of the heat sink of FIG. 7 which illustrates how the combination of the central heat sink segment 14 and the edge heat sink segments 16a,16b combine to form the square planar heat sink 12. In embodiments of the present invention, one or more of the segments of the heat sink 12 may be reconfigured with other segments in order to generate other sizes and/or shapes of heat sinks for installation in troffer assemblies of different size and/or shape. One particular modified heat sink will be described with reference to FIGS. 12 to 15.

Although the heat sink segments 14,16a,16b depicted in FIGS. 5 to 8 have coupling mechanisms that are parallel with their fins, it should be understood that the coupling mechanisms could alternatively be perpendicular to the fins or, in the case that the fins are not parallel with any of the edges of the heat sink segments 14,16a,16b, the coupling mechanisms may have no relationship to the direction of the fins. Further, in some embodiments of the present invention, the fins on the heat sink segments 14,16a, 16b could be replaced or supplemented with other implementations for increasing the surface area of the heat sink segments and/or other cooling techniques.

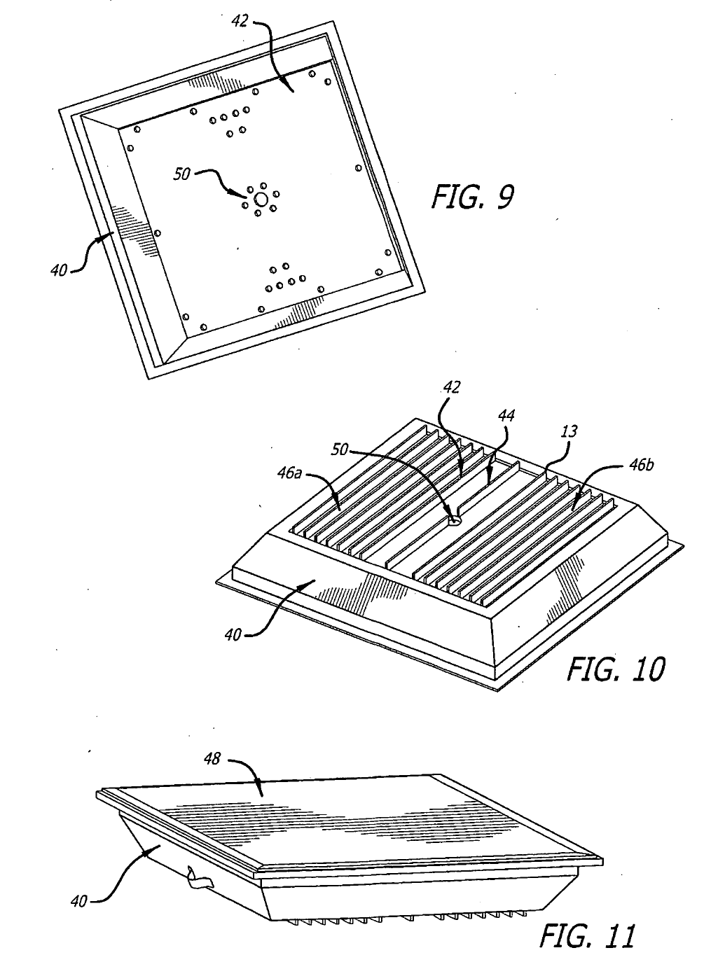

FIGS. 9, 10 and 11 depict an alternative embodiment of the troffer assembly and lighting apparatus to that depicted in FIGS. 1 to 4. In particular, in the embodiment depicted in FIGS. 9, 10 and 11, the troffer assembly and lighting apparatus are significantly reduced in size. In some embodiments, the lighting apparatus of FIGS. 3 and 4 is approximately 2 feet×2 feet while the lighting apparatus of FIG. 11 is 1 foot by 1 foot. Other dimensions for the lighting apparatus of the present invention are possible and these are only sample dimensions.

FIGS. 9 and 10 are top and bottom views respectively of a troffer assembly according to the embodiment of the present invention in which the dimensions are reduced. As shown, the troffer assembly comprises a frame 40 and a heat sink 42 similar to the frame 10 and heat sink 12 described above with reference to FIGS. 1 and 2. Similarly, the frame 40 has four sides that form an edge of a container with front and back square planar sides. The front and back planar sides of the container each have a hole that is substantially the size of the respective planar sides, hence leaving both planar sides open with the frame 40 only forming the outside edge of the container. The heat sink 42 is connected to the frame 40 at the back planar side of the container. Similar to the embodiment of FIGS. 1 and 2, the heat sink 42 has a planar dimension substantially similar to the dimension of the hole in the back planar side of the container. The heat sink 42 is connected to the frame 40 along the edge of the hole in the back planar side of the container such that the hole is fully covered. The heat sink 42 may be connected to the frame 40 with a series of screws or alternatively another fastening mechanism (ex. interlocking connection, clips, snap connection, affixing agent etc.).

As shown in FIGS. 9 and 10, the heat sink 42 comprises first and second planar sides. The first planar side of the heat sink 42 is a flat surface and forms an interior side of the container. When the lighting apparatus according to embodiments of the present invention is assembled, one or more light engine modules (not shown) comprising LEDs are both physically and thermally coupled to the first planar side of the heat sink 42. The second planar side of the heat sink 42 comprises a plurality of fins as shown in FIG. 10 and forms an exterior side of the container. Similar to the heat sink 12, the fins within the heat sink 42 may be implemented in many different manners and may be removed, replaced or supplemented with other cooling technologies. As shown in FIG. 10, the heat sink 42 comprises a central heat sink segment 44 and two edge heat sink segments 46a, 46b connected to the central heat sink segment 44. These three segments are assembled together as will be described in detail with reference to FIGS. 12 to 15.

FIG. 11 is a side view of a lighting apparatus comprising the troffer assembly of FIGS. 9 and 10. As shown, the lighting apparatus comprises the frame 40 and heat sink 42 of FIGS. 9 and 10 and further comprises a planar optical element 48 connected to the frame 40 along the edge of the hole in the front planar side of the container. The optical element 48 may be connected to the frame 40 with an interlocking connection or alternatively another fastening mechanism (ex. screws, clips, snap connection, affixing agent etc.). The planar optical element 18 is used to diffuse light generated from light engine modules (not shown) within the troffer assembly. As shown in FIG. 11, the planar optical element 48 has planar dimensions substantially similar to dimensions of the hole in the front planar side of the frame 40 such that it covers the hole when installed.

Although not shown, the lighting apparatus of FIG. 11 would also comprise an AC/DC supply voltage module and a light control module similar to that depicted above in FIG. 4. Further, similar to the hole 24 within the heat sink 12, the heat sink 42 has a hole 50 that can be used for cabling and can be covered by other components such as an AC/DC power supply module and/or a light control module.

FIGS. 12 through 15 are directed to components of the heat sink 42 and assembly of those components to manufacture the heat sink 42. In this case, the segments 44, 46a, 46b of the heat sink 42 are similar to those described above for the heat sink 12. The difference is the dimensions of the heat sink 42 relative to the heat sink 12, and therefore the dimensions of the heat sink segments 44, 46a, 46b.

In the embodiments of the present invention depicted in FIGS. 12 to 15, the edge heat sink segments 46a, 46b are substantially the same as the edge heat sink segments 16a,16b but with the length of the segments reduced. In this case, the reduction in size of the heat sink 42 relative to the heat sink 12 is primarily due to a change in size of the central heat sink segment 44. By using edge heat sink segments 46a, 46b in the 1×1 troffer assembly of FIGS. 9 and 10 that are substantially the same width and structure as the edge heat sink segments 16a,16b used in the 2×2 troffer assembly of FIGS. 1 and 2, a reduction in SKUs can be used in the manufacturing process of the heat sinks. In particular, a single SKU of edge heat sink segments can be generated for manufacturing of both the 1×1 and 2×2 troffer assemblies. By simply reducing the length of the edge heat sink assemblies 16a,16b, edge heat sink assemblies 46a,46b can be created.

FIGS. 12 and 13 are perspective views of the central heat sink segment 44 and the edge heat sink segment 46a respectively. FIGS. 12a and 13a are magnified views of portions of the segments depicted in FIGS. 12 and 13 respectively. As shown in FIG. 12, the central heat sink segment 44 comprises a relatively narrow longitudinal heat sink element that in this case only comprises a single fin. In other implementations, the central heat sink segment 44 may comprise more than one fin or no fins whatsoever. This central heat sink segment 44 comprises a coupling mechanism on each longitudinal edge similar to the coupling mechanism 26 of FIG. 5. Similarly, the coupling mechanism could be replaced and/or supplemented with alternative mechanisms for coupling the central heat sink segment 44 to the edge heat sink segments 46a,46b. As shown in FIG. 13, the edge heat sink segment 44a comprises a coupling mechanism 54 similar to that of coupling mechanism 28 of FIG. 6.

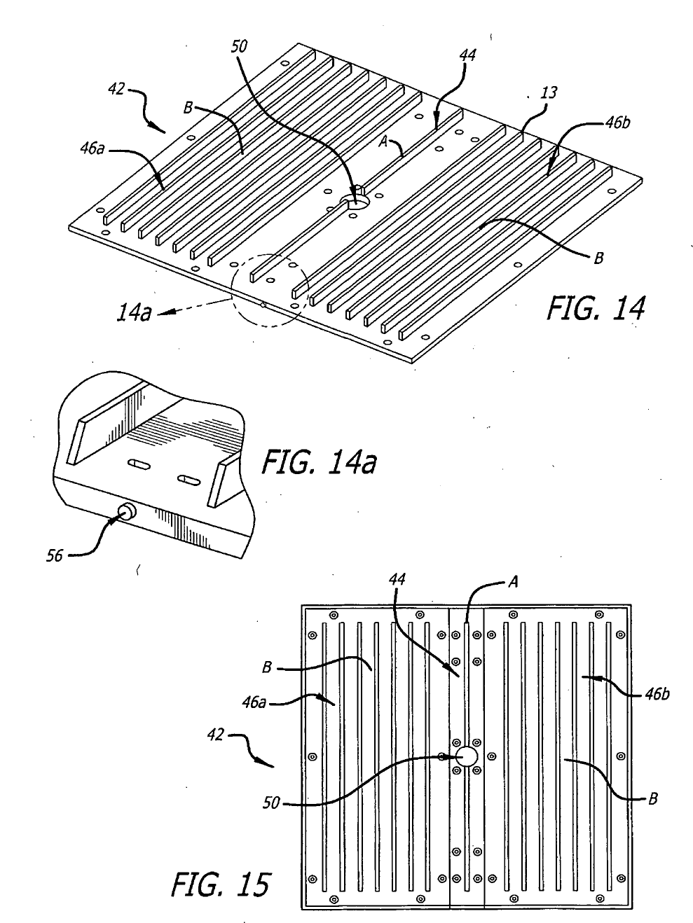

FIG. 14 depicts the elements of achieving interlocking of the heat sinks. FIG. 14 is a perspective view of the heat sink 42 after the central heat sink segment 44 has been assembled with the two edge heat sink segments 46a, 46b. FIG. 14a is a magnified view of a portion of the assembled heat depicted in FIG. 14. As shown, the coupling mechanism 46 of the central heat sink segment 44 and the coupling mechanism 48 of the edge heat sink segment 46a interlock together to form a connection 40. A similar connection can be made between the central heat sink segment 44 and the edge heat sink segment 46b. Further, in some embodiments, other coupling mechanisms may be used as well or in place of the coupling mechanism shown in FIG. 14. For example, to assemble the heat sink segments 44,46a,46b screws, clips, snap connection, affixing agent etc. may be used.

FIG. 15 is a detailed schematic of the heat sink of FIG. 14 which illustrates how the combination of the central heat sink segment 44 and the edge heat sink segments 46a,46b combine to form the square planar heat sink 42. As shown and described above, the edge heat sink segments 46a,46b are similar in dimensions to the edge heat sink segments 16a,16b of FIG. 8 but with their lengths reduced. Their widths remain in both cases the same.

In alternative embodiments of the present invention, instead of changing the dimensions of the central heat sink segment, the edge heat sink segments could be adjusted. In one example implementation, the width of the edge heat sink segments could be reduced substantially while the width of the central heat sink segment would remain constant when reducing the size of the troffer assembly. In this case, the length of the central heat sink segment would need to be reduced but the width could remain constant.

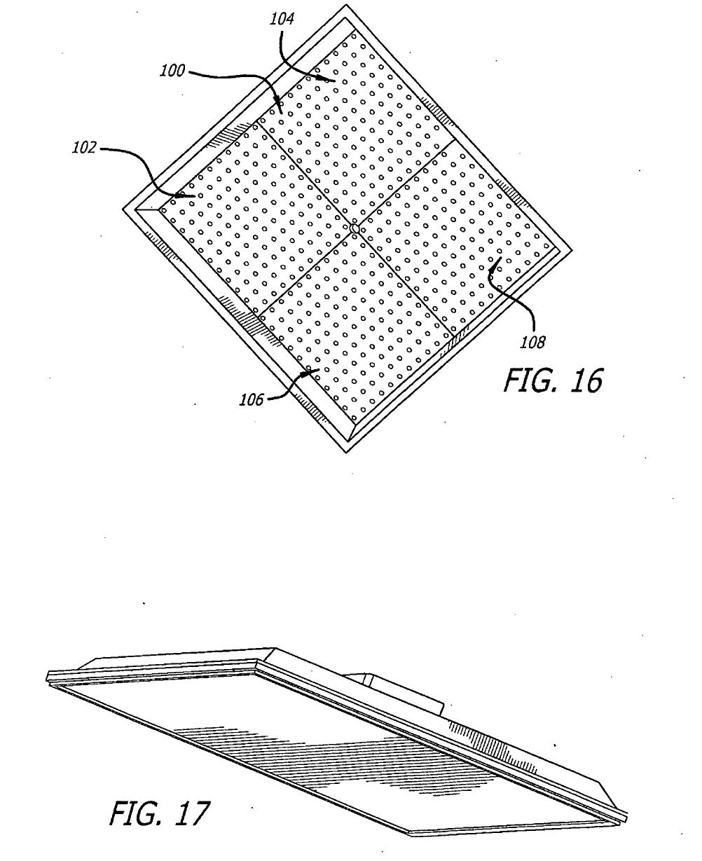

FIG. 16 shows an alternative embodiment in which the troffer assembly 100 includes four modules 102, 104, 106 and 108 instead of one. Each module is complete and independent allowing for economic and efficient of any one module without replacing the others.

FIG. 17 is a perspective view showing the completed lighting assembly.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A heat sink comprising:
a first layer of carbon graphite in thermal communication with a source of heat and
a second layer of aluminum in thermal communication with said first layer.

2. A troffer assembly comprising:
a frame;
a printed circuit board mounted within said frame;
an array of light emitting diodes mounted on said printed circuit board;
a heat sink mounted in parallel with said printed circuit board; and
a thermal interface layer disposed between said heat sink and said printed circuit board.

3. The invention of claim 2 wherein said thermal interface layer is carbon graphite.

4. A troffer assembly comprising:
a frame;
plural modules mounted within said frame, each module including:
a printed circuit board mounted within said frame;
an array of light emitting diodes mounted on said printed circuit board;
a heat sink mounted in parallel with said printed circuit board; and
a thermal interface layer disposed between said heat sink and said printed circuit board.

5. The invention of claim 4 wherein each of said thermal interface layers is carbon graphite.

6. A troffer assembly comprising:
a frame having sides that form an edge of a container with front and back planar sides, the back planar side having at least one hole;
a heat sink having planar dimensions substantially similar to dimensions of the at least one hole in the back planar side of the container, the heat sink connected to the frame along the edge of the at least one hole, whereby the at least one hole in the back planar side of the container is fully covered.

7. The invention of claim 6 wherein the at least one hole in the back planar side of the container is a single hole similar in size to the back planar side of the container.

8. The invention of claim 6 wherein the at least one hole in the back planar side of the container comprises a plurality of holes and the heat sink comprises a plurality of heat sinks; wherein each of the heat sinks has planar dimensions substantially similar to dimensions of one of the plurality of holes in the back planar side of the frame, and each of the heat sinks is connected to the frame along the edge of one of the plurality of holes in the back planar side of the container, whereby the plurality of holes in the back planar side of the container are all fully covered.

9. The invention of claim 6 wherein the at least one heat sink has first and second planar sides, the first planar side forming an interior side of the container and the second planar side forming an exterior side of the container.

10. The invention of claim 9 wherein the second planar side of the at least one heat sink comprises a plurality of fins substantially perpendicular to the second planar side.

11. The invention of claim 6 wherein the at least one heat sink comprises one or more holes for cabling, the one or more holes within the at least one heat sink covered by a module coupled to the at least one heat sink, whereby the at least one hole in the back planar side of the container is fully covered.

12. The invention of claim 6 wherein the at least one heat sink comprises a central heat sink segment and two edge heat sink segments connected on either side of the central heat sink segment, wherein the central heat sink segment combined with the edge heat sink segments have planar dimensions substantially similar to dimensions of the at least one hole in the back planar side of the container.

13. The invention of claim 6 wherein the front planar side of the container has a hole and the frame is adapted to connect a planar optical element in the hole in the front planar side of the container.

14. The invention of claim 13 wherein the hole in the front planar side of the container is similar in size to the front planar side of the container.

15. The invention of claim 13 further comprising a planar optical element having planar dimensions substantially similar to dimensions of the hole in the front planar side of the frame, the planar optical element connected to the frame along the edge of the hole in the front planar side of the container.

16. The invention of claim 6 further comprising at least one light engine module thermally coupled to the at least one heat sink.

17. The invention of claim 16 wherein the at least one light engine module comprises an electrical circuit including light emitting diodes.

18. A modular heat sink comprising:
a central heat sink segment having first and second planar sides and comprising coupling mechanisms on two opposite longitudinal edges;
first and second edge heat sink segments, each having first and second planar sides and comprising coupling mechanisms on one longitudinal edge;
wherein the coupling mechanism of the first and second edge heat sink segments interconnect with the coupling mechanisms of the central heat sink segment such that the modular heat sink comprises a defined shape.

19. The invention of claim 18 wherein the defined shape comprises a square.

20. A modular heat sink assembly comprising:
a central heat sink segment having first and second edges; and
first and second edge heat sink segments connected to the first and second edges of the central heat sink segment, the first and second edge heat sink segments being thermally coupled to the central heat sink segment;
wherein the central heat sink segment combined with the first and second edge heat sink segments are a rectangular shape.

21. A modular heat sink according to claim 20 wherein the rectangular shape is a square.

22. A method of manufacturing a heat sink comprising:
providing a central heat sink segment;
providing first and second edge heat sink segments, each having a longitudinal edge adapted to connect to a longitudinal edge of the central heat sink segment with coupling mechanisms; and
assembling the central heat sink segment with the first and second edge heat sink segments using the coupling mechanisms.

23. The invention of claim 22 further comprising reducing the length of the first and second edge heat sink segments prior to assembling.
